(19) United States
(12) Patent Application Publication
(10) Pub. No.: US 2016/0107207 A1
(43) Pub. Date: Apr. 21, 2016

(54) APPARATUSES, SYSTEMS, AND METHODS FOR CLEANING

(71) Applicant: ECOSERV TECHNOLOGIES, LLC, Lafayette, LA (US)

(72) Inventor: Kenny DesOrmeaux, Abbeville, LA (US)

(73) Assignee: ECOSERV TECHNOLOGIES, LLC, Lafayette, LA (US)

(21) Appl. No.: 14/875,425

(22) Filed: Oct. 5, 2015

Related U.S. Application Data
(60) Provisional application No. 62/066,000, filed on Oct. 20, 2014.

(51) Int. Cl. B08B 9/093; B08B 9/46

(52) U.S. Cl. CPC B08B 9/0936; B08B 9/46

(57) ABSTRACT

Embodiments of the present invention include systems, apparatuses, and methods for cleaning areas. A cleaning apparatus is provided having a programmable, portable, multi axis articulating arm (MAAA). The apparatus may include a base having at least one magnet configured to magnetically mount the apparatus within the areas to be cleaned. The MAAA may have a first end attached to the base and extending away from the base, and a second end attached to a nozzle. The MAAA may have a plurality of connected arm segments. The MAAA may include at least two rotatable joints allowing for manipulation of the nozzle and movement of the apparatus along multiple axes.

### CROSS-REFERENCE TO RELATED APPLICATIONS

This application claims the benefit of U.S. Provisional Patent Application No. 62/060,278, filed on Oct. 6, 2014, and 62/066,000, filed on Oct. 20, 2014, which are incorporated herein by reference.

### FIELD

The present invention relates to apparatuses, systems, and methods for the cleaning of surfaces, and in particular though non-limiting embodiments, to apparatuses, systems, and methods for cleaning containers, tanks, or vessels by fluidizing and removing materials within their interiors using a programmable and articulating arm.

### BACKGROUND

Conventional tank cleaning is often a long, stringent, hazardous, and labor-intensive task. Conventional methods of tank and vessel cleaning require operator exposure to dangerous environments. The work of an operator typically involves manually placing a remotely operated vehicle (ROV) into position in an enclosed and/or confined area, locking the ROV into place, controlling the ROV to perform a specified task, and removing the ROV from the enclosed area. ROVs have traditionally been used for a variety of reasons, including reduced costs, increased time-effectiveness, increased strength capabilities over human workers, and improved safety by reducing man hours spent in confined spaces.

Existing remote tank cleaning systems include a nozzle configured to direct a fluid stream to dislodge, dilute, or dissolve settled solids from tank interiors. These systems generally require extensive mounting or setup within these tanks or containers prior to cleaning, during which workers may be subject to prolonged exposures to the contents being cleaned. Mounted systems may only be able to mount in a limited number of locations within the tanks or containers, limiting the utility of the system. Some systems include extensive robotic components that are bulky, heavy, and difficult to assemble and/or disassemble. Often, the systems cannot be utilized in remote or difficult to reach interiors of tanks, containers, and/or vessels because of the difficulty involved in bringing the system to the site. The systems usually require one or more booms or cranes to place the system near or into a target enclosed area. Additionally, cleaning systems typically involve attachment to or placement upon a floor of a target enclosed area, meaning that the system is placed upon and/or covering a portion of the very sludge/materials the system is intended to clean. Floor mounted systems must also account for other issues in the floor, such as baffles, irregular surfaces, and debris.

On the other hand, cleaning systems that are less bulky or require less assembly are typically insufficiently stable to withstand high water pressures necessary to fluidize settled solids and/or sludge to where they can be easily pumped out. In such cases, the solids and/or sludge must be physically and/or mechanically removed by workers from the interior of enclosed areas, placing the workers in a dangerous and/or toxic environment and therefore at greater risk of exposure to health hazards and injuries.

Additionally, existing tank cleaning systems use fluid directing systems that result in random, wasted movement. For example, some cleaning systems utilize gamma jets that perform cleaning via a 360° spherical spray pattern/movement. However, in these systems, it is not possible to control the cycle of a gamma jet once activated, thereby making it difficult to focus on specific areas in need of cleaning.

Accordingly, a need exists for an improved apparatus, system, and method to remotely remove materials, including settled solids, fluids, slurries, and/or sludge, from a vessel, container, and/or tank interior in a manner that is more efficient and safe than existing systems.

### SUMMARY

Embodiments of the present invention provide for improved methods, systems, and apparatuses for cleaning by implementation of a programmable, portable, multi-axis articulating arm (MAAA) having a plurality of connected arm segments. Embodiments of the present invention provide for purpose driven, focused movement, rather than random, wasted movement. The MAAA may be connected to a track system. Each arm segment may have sensor and positioning components configured to provide a signal to a Programmable Logic Control (PLC) device to ensure correct positioning of the MAAA and track system according to pre-programmed algorithms. The algorithms may provide an efficient manner of cleaning an enclosed area without requiring constant repetitious movements from an operator.

Embodiments of the present invention are configured to work integrally with an operator and amplify the impact of an operator by taking over the most repetitious of tasks. The interoperability of the system with the operator provides a safer and higher quality end product. The operator may be incorporated in the process by overseeing and ensuring the quality of work by the automated process. The programmable MAAA is designed to apply state of the art cleaning techniques with better-than-human accuracy. For example, a typical crew of seven workers may be replaced by a crew of two, resulting in cost reductions and making programmed cleaning an economically viable alternative on a greater number of enclosed areas, potentially leading to an increase in skilled employment in the trade.

The present invention also addresses major safety concerns by reducing and/or eliminating man-hours spent in confined spaces. Embodiments of the present invention provide for a safe, efficient, and cost-saving alternative to placing workers in confined spaces and allow for completion of a safe and successful cleaning job while reducing project turnaround time.

In an example embodiment of the present disclosure, a cleaning apparatus is provided. The cleaning apparatus includes a base having at least one magnet; an arm having a first end attached to the base and extending away from the base; and a nozzle attached to a second end of the arm. The arm may include at least two rotatable joints allowing for manipulation of the nozzle. The base may be configured to magnetically attach to a metal surface. The at least one magnet may be an electromagnet. The apparatus may further include at least one additional magnet configured to attach to the metal surface. The base may include base extensions extending from the at least one magnet at a first end and attaching to a plate at a second end. The apparatus may further include a support beam having a first end attached to the metal surface and a second end attached to the plate. The arm may include a first arm member attached to the plate; and a second arm member attached to the first arm member. The first arm member may be configured to rotate relative to the plate around a first axis. The second arm member may be configured to rotate relative to the first arm member around a second axis that is substantially perpendicular to the first axis. The apparatus may include a pressure line mount configured to facilitate flow of high pressure fluids for cleaning. The pressure line mount may be connected to the second arm member via attachment to the nozzle at a first end and a pressure line at a second end. The nozzle may include dual spay ends. The nozzle may rotate such that each dual spray end spins and provides dual rotating jets of water for breaking-up materials.

The apparatus may include control lines connected to a control station, the control lines configured to control movement of the at least two rotatable joints. The control lines may be at least one of electrical, pneumatic, and hydraulic. The apparatus may be configured to be disassembled into at least two separate components. The at least two separate components may include handles. The arm may include additional arm members such that the arm has more than two axes of articulated movement. The first arm member may include first and second hinge connectors and the second arm member may include third and fourth hinge connectors. The first hinge connector may be fixedly attached to the plate and the second hinge connector may be rotatably attached to the first hinge connector such that the second hinge connector rotates relative to the plate around the first axis. The third hinge connector may be fixedly attached to the second hinge connector and the fourth hinge connector may be rotatably attached to the third hinge connector such that the fourth hinge connector rotates relative to first arm member around the second axis.

In an example embodiment of the present disclosure, a system for cleaning an area is provided. The system includes a cleaning apparatus; at least one camera mounted within the area; and a vacuum line. The cleaning apparatus includes a base having at least one magnet; an arm having a first end attached to the base and extending away from the base; and a nozzle attached to a second end of the arm. The arm may include at least two rotatable joints allowing for manipulation of the nozzle. The apparatus may be configured to spray a fluid via the nozzle and the vacuum line removes the fluid and any materials contained in the fluid. An operator may view the apparatus and area via the at least one camera. The system may include control lines configured to control movement of the at least two rotatable joints. The control lines may be connected to a control station and configured to allow the operator to remotely operate the apparatus. The system may include first and second longitudinal bars movably attached to each other. The apparatus may be movably attached to the first bar. The second bar may be movably attached to a mounting structure. The first and second bars and the apparatus may be movable in multiple directions and axes. The first and second bars may be perpendicularly attached to each other. The apparatus may be magnetically attached to the first bar via the at least one magnet. The second bar may be perpendicularly attached to the mounting structure.

In an example embodiment of the present disclosure, a cleaning and track system is provided. The system includes a cleaning apparatus, a track system, at least one camera mounted within the area; and a vacuum line. The apparatus includes a base; an arm having a first end attached to the base and extending away from the base; and a nozzle attached to a second end of the arm. The arm may include at least two rotatable joints allowing for manipulation of the nozzle. The track system may include first and second longitudinal bars movably attached to each other. The second bar may be movably attached to a mounting structure. The first and second bars may be movable in multiple directions and axes. The apparatus may be movably attached to the track system. The apparatus may be configured to spray a fluid via the nozzle and the vacuum line removes the fluid and any materials contained in the fluid. An operator may view the apparatus and area via the at least one camera. The system may include control lines configured to control movement of the at least two rotatable joints. The control lines may be connected to a control station and configured to allow the operator to remotely operate the apparatus and track system.

In an example embodiment of the present disclosure, a method of cleaning an area is provided. The method includes magnetically mounting a cleaning apparatus within the area; connecting the cleaning apparatus to a high pressure fluid line; remotely operating the cleaning apparatus to control a direction of flow from the high pressure fluid line; directing a flow of fluids towards material on a surface of the area to remove the material from the surface; and removing the fluids and material via a vacuum line. The cleaning apparatus includes a base having at least one magnet; an arm having a first end attached to the base and extending away from the base; and a nozzle attached to a second end of the arm. The arm may include at least two rotatable joints allowing for manipulation of the nozzle. The apparatus may be remotely operated via control lines connected from a control station to the apparatus, the control lines configured to control movement of the at least two rotatable joints. The method may include magnetically attaching the at least one magnet to a track system. The track system may include first and second longitudinal bars movably attached to each other. The apparatus may be movably attached to the first bar. The second bar may be movably attached to a mounting structure. The first and second bars and the apparatus may be movable in multiple directions and axes.

The apparatus may be programmed by the steps of instructing a route to the apparatus by the steps of controlling the apparatus and defining the route via implementation of a starting cleaning sequence, and logging resulting route data from sensor and positioning components to a memory. The sensor and positioning components may be located on at least one of the apparatus and track system. The route may include an initial cleaning of the area including a sequence of maneuvers positioning the apparatus for optimal cleaning purposes. The apparatus may further be programmed by the steps of processing logged route data into a route profile, and reproducing the route profile automatically using a Programmable Logic Control (PLC) device. The route profile may include a defined optimal cleaning sequence. The apparatus may be operated by the steps of implementing the starting cleaning sequence using the PLC device; sending the signal to an Electro-Hydraulic Flow Control (EHFC) device via the PLC device; positioning the apparatus and arm in an optimal cleaning position based on the signal and flow via the EHFC device; and performing a cleaning motion for a pre-determined amount of time according to the defined optimal cleaning sequence. The PLC device may be configured to receive an electrical signal from the sensor and positioning components once the starting cleaning sequence is implemented. The EHFC device may be configured to provide at least one of hydraulic, pneumatic, and electrical flow. The PLC device may be configured to repeat the defined optimal cleaning sequence by simultaneously sending and receiving signals. The method may include observing movements of the cleaning apparatus and track system via at least one camera mounted within the area or on the apparatus. The steps for operating the apparatus may be repeated until the area is cleaned. The method may include turning off the at least one magnet to dismount the cleaning apparatus. The at least one magnet may be electro-magnetic.

In an example embodiment of the present disclosure, a cleaning apparatus is provided. The apparatus includes a base; an arm having a first end attached to the base and extending away from the base; and a nozzle attached to a second end of the arm. The arm may include at least two rotatable joints allowing for manipulation of the nozzle. The apparatus may include base extensions extending from the base at a first end and attaching to a plate at a second end. The arm may include a first arm member attached to the plate; and a second arm member attached to the first arm member. The first arm member may be configured to rotate relative to the plate around a first axis. The second arm member may be configured to rotate relative to the first arm member around a second axis that is substantially perpendicular to the first axis. The apparatus may include a pressure line mount configured to facilitate flow of high pressure fluids for cleaning. The pressure line mount may be connected to the second arm member via attachment to the nozzle at a first end and a pressure line at a second end. The apparatus may include control lines connected to a control station, the control lines configured to control movement of the at least two rotatable joints.

### DESCRIPTION OF DRAWINGS

FIG. 1 is an isometric view of a cleaning apparatus, according to an exemplary embodiment of the present invention;

FIG. 2 is an isometric view of the cleaning apparatus shown in FIG. 1;

FIG. 3 is a top view of the cleaning apparatus shown in FIG. 1;

FIG. 4 is a isometric view of a cleaning and track system, according to an exemplary embodiment of the present invention;

FIG. 4A is an enlarged partial cutaway view of an attachment within the cleaning and track system shown in FIG. 4;

FIG. 4B is an enlarged partial cutaway view of another attachment within the cleaning and track system shown in FIG. 4;

FIG. 5 is a flow chart depicting a method of programming a cleaning and track system, according to an exemplary embodiment of the present invention;

FIG. 6 is a flow chart depicting a method of cleaning using a programmable cleaning and track system, according to an exemplary embodiment of the present invention.

### DETAILED DESCRIPTION

Embodiments of the present invention include a cleaning apparatus having a programmable, portable, MAAA. The apparatus may be mounted on a wall in an interior of an enclosed area to be cleaned. The enclosed area may include interiors and/or exteriors of containers, vessels, tanks, or any other structures that require cleaning. The apparatus may also be mounted on a manhole or similar opening. The apparatus may include at least one magnet configured to magnetically mount the apparatus. Magnetic mounting allows for the apparatus to be mounted at virtually unlimited locations with the enclosed area, allowing for more focused and efficient cleaning and simple removal. The apparatus may also be bolted in place. The apparatus may include a high pressure fluid line and high pressure nozzles. The apparatus may be configured for remote operation by an operator outside of the enclosed area being cleaned.

Embodiments of the present invention also include a cleaning and track system. Cleaning and track system includes a cleaning apparatus as described herein mounted to a track system and/or mounting structure placed within an enclosed area whereby the MAAA of apparatus may be movable through additional axes within an enclosed area. Cleaning and track system may be controlled manually or from pre-programmed algorithms through a PLC device. Sensor and positioning components on the MAAA and/or track system may provide a signal to the PLC device to ensure correct positioning of the MAAA and/or track system according to the pre-programmed algorithms.

Cleaning apparatus and/or cleaning and track system are configured such that they may be attached within the enclosed area at a location near an area targeted for cleanup. Embodiments of the present invention are durable and allow for precise control of water flows, which may be directed at specific problem or target areas rather than merely cycling to clean the entire enclosed area. Performing targeted cleaning allows for increased efficiency and decreased waste.

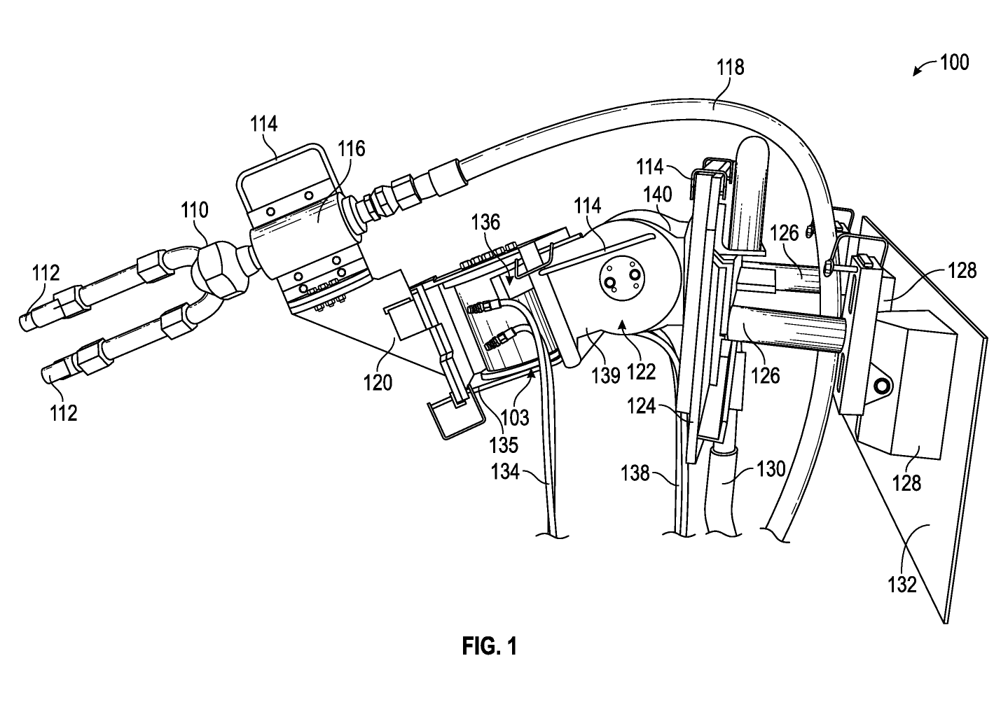

Referring now to FIGS. 1 to 3, different views of a cleaning apparatus 100 are shown. Apparatus 100 includes a MAAA 103. MAAA 103 includes a plurality of connected arm segments having a first arm member 122 and second arm member 136. In other embodiments, the MAAA may have more or less arm members. First arm member 122 extends from plate 124. Second arm member 136 is attached to first arm member 122 distal to plate 124.

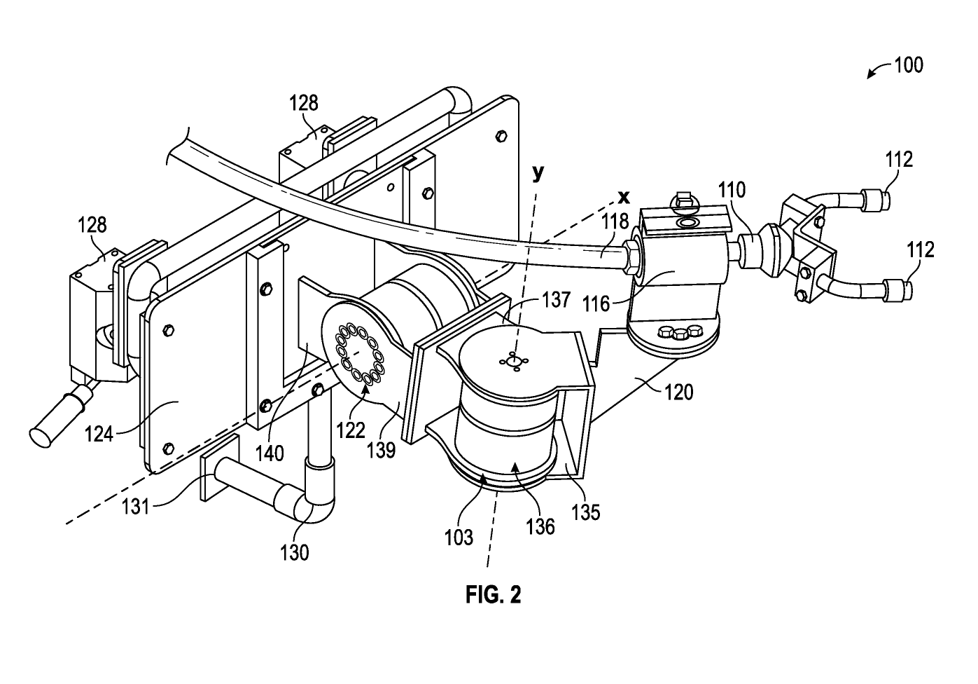

First and second arm members 122, 136 may each include at least one rotatable joint configured so that the arm members 122, 136 may be manipulated in multiple directions. In exemplary embodiments, first arm member 122 includes first and second hinge connectors 140, 139. First hinge connector 140 is fixedly attached to plate 124. Second hinge connector 139 is rotatably attached to first hinge connector 140 such that second hinge connector 139 rotates relative to plate 124 along a first axis of rotation. As shown in FIG. 2, second hinge connector 139 rotates around the X-axis.

Second arm member 136 includes third and fourth hinge connectors 137, 135. Third hinge connector 137 is fixedly attached to second hinge connector 139. Fourth hinge connector 135 is rotatably attached to third hinge connector 137 such that fourth hinge connector 135 rotates relative to first arm member 122 along a second axis of rotation that is substantially perpendicular to the first axis of rotation of the first arm member 122 relative to plate 124. As shown in FIG. 2, fourth hinge connector 135 rotates around the Y-axis.

The combination of the rotation of first arm member 122 and second arm member 136 allows for MAAA 103 to be moved up and down and side to side, covering the entire surface of the interior of the enclosed area. In some embodiments, first arm member 122 and second arm member 136 may include swivel connectors and/or any other connections/joints to facilitate cleaning by apparatus 100. In other embodiments, the number and location of the hinge connectors and/or swivel connectors may be varied to achieve movement of apparatus 100 along additional axes.

Elbow member 120 is attached to second arm member 136. Particularly, elbow member 120 is attached to fourth hinge connector 135. See FIG. 2. Elbow member 120 extends away from second arm member 136 and attaches to pressure line mount 116. Nozzle 110 is attached to a first end of pressure line mount 116. Pressure line 118 is attached to a second end of pressure line mount 116. As shown in FIGS. 1 to 3, nozzle 110 includes dual spray ends 112. Nozzle 110 may be a variable speed nozzle that rotates, thereby spinning each dual spray end 112 and providing dual rotating jets of fluids, e.g. water, for breaking-up and fluidizing materials. Alternatively, nozzle 110 may include a single spray end and/or any other configuration designed to provide fluid at high pressures and fluidize material. Water flow may be provided at high pressures and high flow rates. In exemplary embodiments, the water flow is approximately 100 GPM at approximately 900 PSI. Larger flow rates and pressures are possible by increasing magnetic strength, numbers, and configurations of components of apparatus 100, and/or by providing additional supports for mounting apparatus 100 against the interior wall 132 and/or floor of the enclosed area.

Apparatus 100 includes a base with a pair of magnets 128 configured to mount apparatus 100 to wall 132 within an enclosed area. See FIG. 1. In this embodiment, wall 132 is made of metal or has metallic properties such that magnets 128 may easily attach to wall 132. Magnets 128 may be sufficiently strong to withstand the forces of the apparatus 100 during manipulation and cleaning while maintaining its location within the enclosed area. In exemplary embodiments, magnets 128 are electro-magnets supplied with controllable electric current such that the magnetic field is “turned off” for removal of apparatus 100. In other embodiments, wall 132 may not be made of metal or have metallic properties such that a metallic material may have to be placed on an outside surface of the wall 132 to allow for magnets 128 to mount apparatus 100 to wall 132 via attraction of magnets 128 to metallic material. Although disclosed as attaching to wall 132 via magnets 128, apparatus 100 may utilize any other permanent and/or non-permanent mechanisms to attach to wall 132.

Base may include base extensions 126 connected to magnets 128 at one end and plate 124 at a second end. See, e.g., FIG. 1. Support beam 130 may be attached to plate 124 or extensions 126 at a first end and to wall 132 at a second end 131. See, e.g., FIG. 2. Support beam 130 may have a curved shape, flat shape, or any other shape to support apparatus 100.

Apparatus 100 may include handles 114 to allow a worker to carry components of MAAA 103 to a desired location. See, e.g., FIG. 1. Apparatus 100 may separate into two or more components for transport. In a specific embodiment, apparatus 100 may separate into five separate components, allowing for easy transport and access to difficult to reach locations. Apparatus 100 may be assembled within an enclosed area, or outside the enclosed area and placed into the area fully assembled.

First and second arm members 122, 136 may be connected to control lines 134, 138. See, e.g., FIG. 1. Control lines 134, 138 are configured to control movement, i.e., rotation of first and second arm members 122, 136 via pneumatics, electronics, hydraulics, or any applicable combination thereof.

Apparatus 100 may be remotely controlled by an operator at a control station external to the enclosed area. Control station is operatively connected to the apparatus 100 and transmits signals to apparatus 100 via control lines 134, 138 based on the operator's input at the control station. In embodiments, a camera may be attached to the enclosed area prior to apparatus 100 being mounted to the enclosed area, or may be attached to apparatus 100 prior to mounting. Display device may also be provided at the control station so that the operator may monitor apparatus 100 inside the enclosed area via the camera and make any necessary adjustments to apparatus 100.

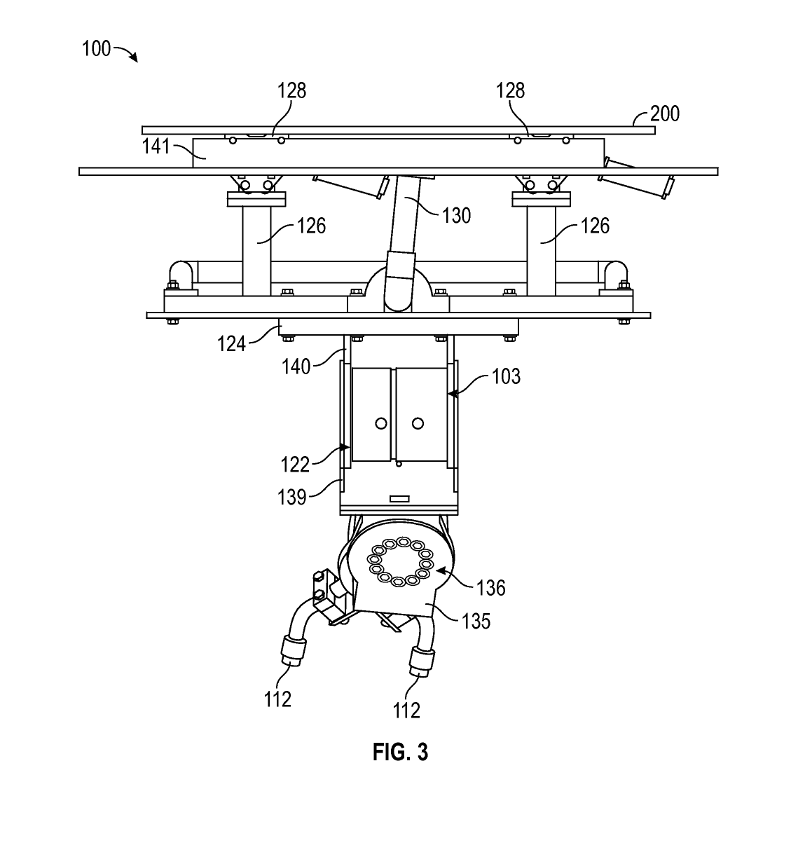

In some embodiments, apparatus 100 may be attached to an external plate 200 and placed into an enclosed area at a manway access point 141. See, e.g., FIG. 3. In this embodiment, the apparatus 100 is attached to the external plate 200 and then lowered into the enclosed area to be cleaned. External plate 200 may be sufficiently wider than the manway access point 141 to ensure that external plate 200 remains external and only the apparatus 100 reaches into the enclosed area. External plate 200 may include one or more holes for line access such as a vacuum line and/or pressurized fluid line. External plate 200 may include handles for maneuvering.

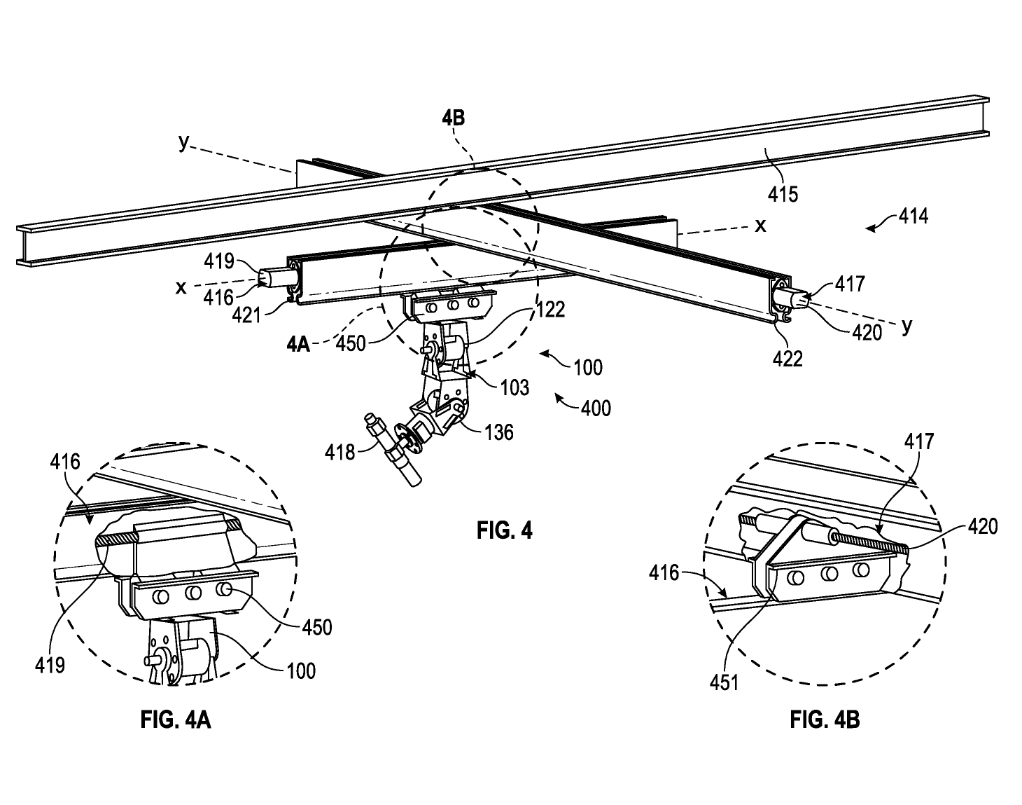

Referring now to FIG. 4, a cleaning and track system 400 is shown. Cleaning and track system 400 may include the cleaning apparatus 100 disclosed herein attached to track/drive system 414 and/or a mounting support structure 415, whereby apparatus 100 and/or track/drive system 414 may be movable through multiple axes within an enclosed area. Cleaning and track system 400 may be automated and/or remotely operable. Cleaning and track system 400 may be controlled via hydraulic, pneumatic, and/or electrical methods.

As shown in FIG. 4, the cleaning and track system 400 includes the cleaning apparatus 100 disclosed herein including a MAAA 103 having a first arm member 122 and second arm member 136. MAAA 103 is connected to a single high pressure water nozzle 418 configured to provide for additional impact force at the area being cleaned. Alternatively, the MAAA may be connected to the nozzles 110 described herein or any other configuration of nozzles 110.

Cleaning apparatus 100 is attached to a track/drive system 414. As shown, the track/drive system 414 includes two generally inverted U-shaped structures or bars 416, 417 attached to each other. In an exemplary embodiment, bars 416, 417 are perpendicularly attached to each other. In other embodiments, the structures or bars 416, 417 may have a generally inverted V-shape or any other shape. Each inverted U-shaped bar 416, 417 includes a rod 419, 420 movably attached between two opposing generally inverted and curved hook or T-shaped track supports 421, 422. Alternatively, the track supports 421, 422 may have any other shape suitable for performing functions of the track/drive system 414. In exemplary embodiments, rods 419, 420 may be Acme threaded rods mounted within bars 416, 417. In some embodiments, rods 419, 420 may be mounted within bars 416, 417 via a threaded rod-nut connection. Rods 419, 420 may be connected at their ends to motors and configured to generate linear motion and provide rapid, lateral movement. Nuts may further be welded to each end of rods 419, 420 to limit movement of rods 419, 420 within bars 416, 417. Rods 419, 420 may be rotated within each bar 416, 417 via hydraulic, pneumatic, and/or electrical power.

Cleaning apparatus 100 is attached to first bar 416 such that cleaning apparatus 100 may be movable and/or driven along the length of the first bar 416. Cleaning apparatus 100 may be magnetically attached to first bar 416 or attached via a first trolley unit 450 as described herein. Alternatively, cleaning apparatus 100 may be attached to first bar 416 via any other attachment mechanisms. Apparatus 100 may be remotely controlled and mechanically driven along first bar 416. As shown in FIG. 4, cleaning apparatus 100 is movable along the X-axis. First bar 416 is attached to second bar 417 such that the first bar 416 may be movable and/or driven along the length of the second bar 417. First bar 416 may be magnetically attached to second bar 417 or attached via a second trolley unit 451 as described herein. Alternatively, first bar 416 may be attached to second bar 417 via any other attachment mechanisms. First bar 416 may be remotely controlled and mechanically driven. As shown in FIG. 4, first bar 416 and attached cleaning apparatus 100 are movable along the Y-axis. Cleaning apparatus 100, first bar 416, and second bar 417 may be attached to each other via any attachment mechanism such that each respective points of attachment tracks along the respective rod 419, 420 within each bar 416, 417.

FIGS. 4A and 4B show enlarged cutaway views of trolley units 450, 451 attached to apparatus 100, first bar 416, and second bar 417. Referring to FIG. 4A, a first trolley unit 450 is shown. First trolley unit 450 is attached to apparatus 100 at a first end and first bar 416 at a second end. As shown, first trolley unit 450 is attached to apparatus 100 at the first end via bolting. However, first trolley unit 450 may be attached to apparatus 100 via any other permanent or temporary attachment mechanisms. First trolley unit 450 is secured to first bar 416 via mounting on rod 419 within first bar 416. As shown, first trolley unit 450 is mounted on rod 419 via a plate attached to a cylindrical tubing with threaded insert to allow for insertion of threaded rod 419. Alternatively, first trolley unit 450 may be attached to first bar 416 via any other permanent or temporary attachment mechanisms. In some embodiments, the plate attached to first trolley unit 450 may have a square or rectangular shape. However, plate may have any other shape to facilitate connection between apparatus 100 and first bar 416. Motors at ends of rod 419 may then rotate rod 419 and generate linear motion to facilitate movement of first trolley unit 450 and/or apparatus 100 along first bar 416.

Referring to FIG. 4B, a second trolley unit 451 is shown. Second trolley unit 451 is attached to first bar 416 at a first end and second bar 417 at a second end. Second trolley unit 451 may be attached to first bar 416 and second bar 417 via substantially the same attachment configuration as the attachment of first trolley unit 450 to apparatus 100 and first bar 416. As shown, the plate attached to second trolley unit 451 may have a triangular shape. However, plate may have any other shape to facilitate connection between first bar 416 and second bar 417. Motors at ends of rod 420 may rotate rod 420 and generate linear motion to facilitate movement of second trolley unit 451 and/or first bar 416 along second bar 417. Although shown in this configuration, rods 419, 420 may be movably attached within bars 416, 417 via any other mechanisms known to a person of ordinary skill in the art so as to allow for lateral movement of rods 419, 420 within bars 416, 417. In some embodiments, bars 416, 417 may be attached to each other via magnets. Magnets may be permanent magnets or electromagnets. In other embodiments, bars 416, 417 may be attached to each other via any other temporary or permanent attachment mechanisms.

In some embodiments, ends of track supports 421, 422 may further extend away from bars 416, 417 so as to attach bars 416, 417 to a wall or other surface via magnets or any other temporary or permanent attachment mechanisms. In embodiments, bar 416 may be pre-mounted to an interior surface of a container and bar 417 may be subsequently inserted into the container and mounted onto bar 416.

Cleaning and track system 400 may be attached to a mounting bar/support structure 415 via magnets or any other temporary or permanent attachment mechanisms. Cleaning and track system 400 may be strategically placed according to any specific positioning required for comprehensive movement within an enclosed area. In exemplary embodiments, mounting bar 415 is a longitudinal I-beam. However, mounting bar 415 may be a rounded rod/bar and/or have any other shape for attachment of cleaning and track system 400. As shown in FIG. 4, second bar 417 is perpendicularly attached to the mounting bar/structure 415. This particular configuration of the drive system 414 and mounting structure 415 allows the cleaning apparatus 100 and MAAA 103 to move in a multitude of directions within an enclosed area—including but not limited to horizontal, vertical, circular, and/or spiral directions so as to cover any and all enclosed areas. Mounting bar 415 may be mounted within an interior of the enclosed area. In other embodiments, mounting bar 415 may be lowered or inserted into any area to be cleaned, including manholes.

Depending on the configuration of an area to be cleaned, multiple different arrangements of the track system 400 and/or mounting bar 415 are possible. Although disclosed as being connected perpendicularly, the first and second bars 416, 417 and mounting structure 415 may be attached to each other in any other configuration necessary to assist apparatus 100 in performing its cleaning functions. In embodiments, each component of the cleaning and track system 400, including cleaning apparatus 100, first bar 416, and second bar 417, as well as mounting bar/support structure 415 may be separately mounted within or outside a container, and/or may be maneuvered into the container as separate components or as a pre-mounted system/apparatus prior to cleaning. For example, in some embodiments, track/drive system 414 may be mounted within container, and apparatus may be lowered into container and attached to track/drive system 414. In other embodiments, apparatus 100 may be mounted within container and track/drive system 414 may be lowered into container and attached to apparatus 100. In yet other embodiments, first bar 416 of track/drive system 414 may be mounted within container and second bar 417 of track/drive system 414 may be lowered into container and attached to first bar 416. In some embodiments, mounting bar 415 may be mounted within container and track system 400 and/or its individual components may be lowered into container and attached to mounting bar 415.

A vacuum line may be placed on or near the floor of an area to be cleaned and may be configured to remove water and fluidized debris/materials from the area. One or more cleaning apparatuses 100 and/or cleaning and track systems 400 may be placed within an area to be cleaned. Cleaning and track system 400 may further be used in conjunction with other cleaning systems, for example, the systems described in U.S. patent application Ser. Nos. 13/135,018 and 14/530,455, all of which are incorporated herein by reference.

Cleaning and track system 400 may be controlled manually or from pre-programmed algorithms through a PLC device. In exemplary embodiments, the cleaning and track system 400 includes sensor and positioning components affixed to the MAAA 103 and/or track/drive system 414, and that are configured to send relevant positioning and other data to the PLC device. Sensor and positioning components may include a laser based device, an ultrasonic based device, an optical based device, or other similar devices. In particular embodiments, the laser sensor may be a rangefinder sensor such as a SICK Optic Laser Scanner.

Cleaning and track system 400 may be programmed via operational steps of Instructing (or Teaching), Route Profiling, and Reproduction (or Playback). Methods using these particular operational steps are disclosed in U.S. Pat. No. 8,260,483, which is incorporated herein by reference. Specifically, the patent discloses methods including instructing/teaching a route and logging resulting route data from sensors to a memory; processing the logged data into a route profile (comprised of, in this case, a cleaning sequence); and reproducing/playing back the profiled route automatically using a control system.

Instructing or Teaching is an online operation whereby an operator may manually or remotely control the apparatus 100 and/or cleaning and track system 400 described herein through a PLC device. In exemplary embodiments, the PLC device may be any known PLC device that uses the IQAN electronic control system with a MD3 Module. PLC devices are standard in many industrial automation systems and used to synchronize overall system operation such that robot controller resources may be focused only on robot arm operation. The purpose of the instructing or teaching method is to allow an operator to define a cleaning route or sequence to be subsequently played back. The route may constitute an initial cleaning of an enclosed area including an arbitrary sequence of maneuvers positioning the apparatus 100 and/or cleaning and track system 400 for optimal cleaning purposes.

Under the next Route Profiling step, generally an offline activity, positioning data is derived from the sensor and positioning components attached to the MAAA 103 and/or track/drive system 414. Systems and apparatuses utilizing MAAAs and sensor and positioning components to derive positioning data are disclosed in U.S. Pat. Nos. 8,942,940, 8,997,362, and 8,965,571, which are incorporated herein by reference. Particularly, these patents disclose connected arm segments including at least one position transducer for producing a position signal, an electronic circuit for receiving the position signals from the transducer and for providing data corresponding to a position of a nozzle connected to the arm segments, and logic executable by the electronic circuit.

Once received from the sensor and positioning components, the positioning data is then logged to a log file on a processor in a computer or similar device for processing at a later point; the purpose being to define a route, for subsequent reproduction, by operating the MAAA 103 according to certain conditions. The computer may be located remotely at the control station or in another location near the area being cleaned. A log file may be a file on a mass storage device accessible by a computer processor attached and/or connected to the apparatus 100, containing time-stamped sensor readings that were recorded during the instructing/teaching run along the route. Particularly, raw data is compiled and processed to create a particular route profile configured to profile a particular enclosed area. In exemplary embodiments, the route profile includes information representing a cleaning sequence configured to assist in cleaning the enclosed area.

Once generated, the Route Profile is then implemented in the next step—Reproduction or Playback. Reproduction is an online method whereby the PLC device is configured to automatically reproduce or playback the cleaning sequence using the saved Route Profile, and also constantly monitor the sensor and positioning components. PLC device is configured to repeat the pre-programmed cleaning sequence by sending and receiving signals simultaneously.

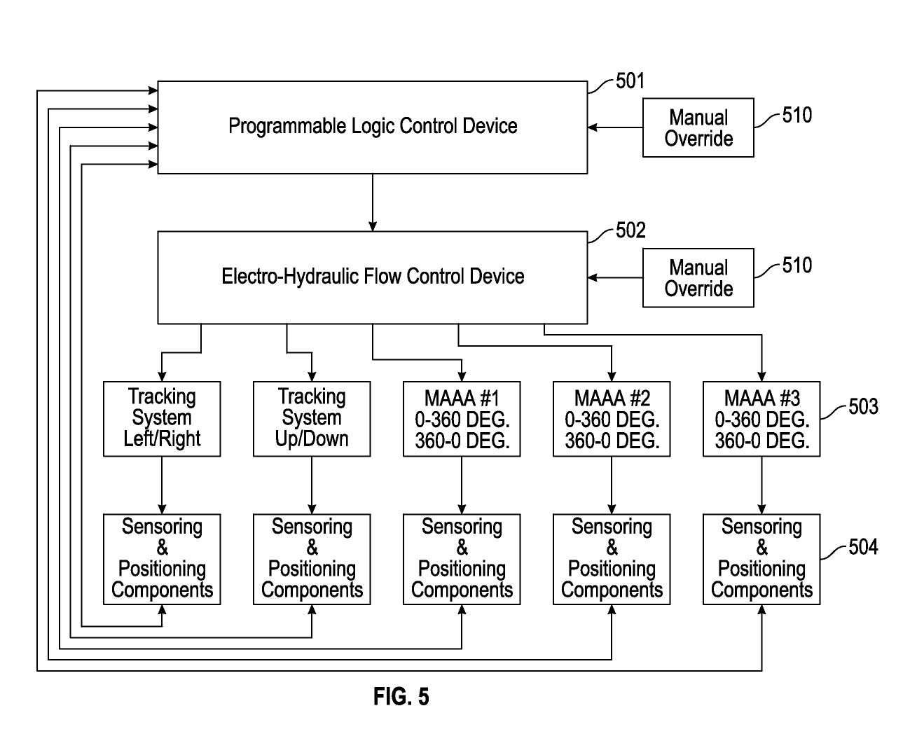

Referring now to FIG. 5, a flow chart depicting a method of programming the cleaning and track system 400 is shown. PLC 501 controls all movement of the track system and/or MAAA 503 by sending an electrical signal to an Electro-Hydraulic Flow Control (EHFC) device 502. In exemplary embodiments, the EHFC device may be any known EHFC device that uses a Continental Directional Control valve with 24 volt DC solenoids. SWH-GO-C4-D24-20 and VEDO3M-3AC-16-A-K1-24DC may be two different size controllers on the valve. EHFC device 502 is configured to receive the electric signal from the PLC device 501, and thereby control nozzle valve operation of apparatus 100. EHFC device 502 may be configured to provide hydraulic, pneumatic and/or electrical output.

In some embodiments, the PLC device 501 may bypass control of the EHFC device 502 by providing direct electrical signals to the track system and/or MAAA 503. In other embodiments, as shown in FIG. 5, PLC device 501 provides direct electrical signals to the sensor and positioning components 504. Sensor and positioning components 504 may include but are not limited to linear transducers, angle transducers, magnetic transducers, and thermal light imaging devices. Sensor and positioning components 504 may be located in multiple different areas on the track system and/or MAAA 503 and may provide a multitude of different functions.

Manual overrides 510 may be accomplished at any time during operation and programming of the cleaning sequence. Overrides 510 may occur through control of the PLC device 501 or the EHFC device 502. Overrides 510 may be accomplished by using control mechanisms located within a cabin/control station located remotely, which may then override automated controls of the PLC device. Overrides 510 may also be accomplished via manual valve control through a lever system within the EHFC device. Finally, these steps may be repeated until the desired optimal cleaning sequence is completed.

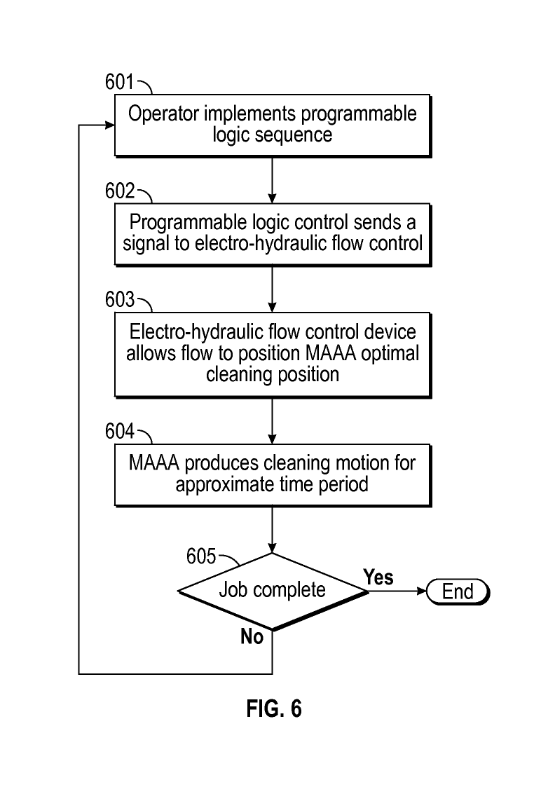

Referring now to FIG. 6, a flow chart depicting a method of cleaning using a programmable cleaning and track system 400 is shown. The method includes a first step 601 of using an operator to implement a programmable starting logic sequence configured to allow the PLC device 501 as disclosed herein to begin sending and receiving signals. Operator may typically be a skilled person who works with the cleaning and track system 400 to ensure that the system 400 functions properly, perform ongoing quality control, and provide an overall level of craftsmanship that may be lacking in a fully automated system. Alternatively, the sequence may be implemented without an operator.

In the next step 602, once the sequence is implemented, the PLC device 501 begins to receive a signal from the sensor and positioning components 504, thereby allowing the PLC device 501 to send the correct signal to the EHFC device 502.

In the next step 603, the EHFC device 502 receives the signal from the PLC device 501, and then provides for resulting hydraulic, pneumatic and/or electrical flow to position the track system and/or MAAA 503 in an optimal cleaning position.

In the next step 604, track system and/or MAAA 503, produce the optimal cleaning motion for a pre-determined time period according to pre-programmed algorithms. This optimal cleaning motion includes smooth and consistent maneuvers of the track system and/or MAAA 503, and further limits useless, random, and wasted movement of the system by targeting a specific area for cleaning within an enclosed area. The specific time to clean an enclosed area or other surface may vary depending on several factors, including but not limited to the size of the area or surface to be cleaned and the amount of material to be cleaned. Embodiments of the present invention may provide for at least a 33% reduction in overall cleaning time compared to existing systems.

Finally, in step 605, if an area has been sufficiently cleaned, the cleaning process is completed and the track system and/or MAAA 503 may be removed from the area. However, if the area requires further cleaning, steps 602, 603, 604 for cleaning using the programmed cleaning and track system 400 and cleaning sequence may be repeated until the area has been fully cleaned. If additional areas require cleaning, the cleaning and track system 400 may be moved to those areas, and steps 601, 602, 603, 604 for cleaning may be repeated until the areas have been fully cleaned.

In embodiments of the present invention, a method of cleaning an area is provided. The method includes delivering/moving a cleaning apparatus 100 and/or cleaning and track system 400 as described herein to the area to be cleaned. Cleaning apparatus 100 and/or cleaning and track system 400 may be assembled within the area or may be assembled prior to being placed within the area. The method includes mounting the apparatus 100 and/or cleaning and track system 400 within or near the area. The method includes connecting the apparatus 100 to a high pressure fluid line, remotely operating the apparatus 100 to control a direction of flow from the high pressure fluid line, directing the flow of fluids towards material on a surface of the area to remove the material from the surface, and removing the fluids and material via a vacuum line. Once cleaning is complete, the apparatus 100 and/or cleaning and track system 400 may be removed from the area.

While the embodiments are described with reference to various implementations and exploitations, it will be understood that these embodiments are illustrative and that the scope of the inventions is not limited to them. Many variations, modifications, additions, and improvements are possible. Further still, any steps described herein may be carried out in any desired order, and any desired steps added or deleted.

What is claimed is:

1. A cleaning apparatus, comprising:
a base having at least one magnet;
an arm having a first end attached to the base and extending away from the base; and
a nozzle attached to a second end of the arm,
wherein the arm includes at least two rotatable joints allowing for manipulation of the nozzle,
wherein the base is configured to magnetically attach to a metal surface.

2. The apparatus of claim 1, wherein the at least one magnet is an electromagnet.

3. The apparatus of claim 1, further comprising at least one additional magnet configured to attach to the metal surface.

4. The apparatus of claim 3, wherein the base includes base extensions extending from the at least one magnet at a first end and attaching to a plate at a second end.

5. The apparatus of claim 4, further comprising a support beam having a first end attached to the metal surface and a second end attached to the plate.

6. The apparatus of claim 5, wherein the arm includes:
a first arm member attached to the plate; and
a second arm member attached to the first arm member,
wherein the first arm member is configured to rotate relative to the plate around a first axis,
wherein the second arm member is configured to rotate relative to the first arm member around a second axis that is substantially perpendicular to the first axis.

7. The apparatus of claim 6, further comprising a pressure line mount configured to facilitate flow of high pressure fluids for cleaning, wherein the pressure line mount is connected to the second arm member via attachment to the nozzle at a first end and a pressure line at a second end.

8. The apparatus of claim 1, wherein the nozzle includes dual spay ends, and wherein the nozzle rotates such that each dual spray end spins and provides dual rotating jets of water for breaking-up materials.

9. The apparatus of claim 1, further comprising control lines connected to a control station, the control lines configured to control movement of the at least two rotatable joints.

10. The apparatus of claim 9, wherein the control lines are at least one of electrical, pneumatic, and hydraulic.

11. The apparatus of claim 1, wherein the apparatus is configured to be disassembled into at least two separate components.

12. The apparatus of claim 11, wherein the at least two separate components include handles.

13. The apparatus of claim 6, wherein the arm includes additional arm members such that the arm has more than two axes of articulated movement.

14. The apparatus of claim 6, wherein the first arm member includes first and second hinge connectors and the second arm member includes third and fourth hinge connectors.

15. The apparatus of claim 14, wherein the first hinge connector is fixedly attached to the plate and the second hinge connector is rotatably attached to the first hinge connector such that the second hinge connector rotates relative to the plate around the first axis, wherein the third hinge connector is fixedly attached to the second hinge connector and the fourth hinge connector is rotatably attached to the third hinge connector such that the fourth hinge connector rotates relative to first arm member around the second axis.

16. A system for cleaning an area, comprising:
a cleaning apparatus, comprising:
a base having at least one magnet;
an arm having a first end attached to the base and extending away from the base; and
a nozzle attached to a second end of the arm,
wherein the arm includes at least two rotatable joints allowing for manipulation of the nozzle;
at least one camera mounted within the area; and
a vacuum line,
wherein the apparatus is configured to spray a fluid via the nozzle and the vacuum line removes the fluid and any materials contained in the fluid,
wherein an operator views the apparatus and area via the at least one camera.

17. The system of claim 16, further comprising:
control lines configured to control movement of the at least two rotatable joints,
wherein the control lines are connected to a control station and are configured to allow the operator to remotely operate the apparatus.

18. The system of claim 17, further comprising:
first and second longitudinal bars movably attached to each other,
wherein the apparatus is movably attached to the first bar,
wherein the second bar is movably attached to a mounting structure,
wherein the first and second bars and the apparatus are movable in multiple directions and axes.

19. The system of claim 18, wherein the first and second bars are perpendicularly attached to each other.

20. The system of claim 18, wherein the apparatus is magnetically attached to the first bar via the at least one magnet.

21. The system of claim 18, wherein the second bar is perpendicularly attached to the mounting structure.

22. A cleaning and track system, comprising:
a cleaning apparatus, comprising:
a base;
an arm having a first end attached to the base and extending away from the base; and
a nozzle attached to a second end of the arm,
wherein the arm includes at least two rotatable joints allowing for manipulation of the nozzle;
a track system, comprising:
first and second longitudinal bars movably attached to each other,
wherein the second bar is movably attached to a mounting structure,
wherein the first and second bars are movable in multiple directions and axes;
at least one camera mounted within the area; and
a vacuum line,
wherein the apparatus is movably attached to the track system,
wherein the apparatus is configured to spray a fluid via the nozzle and the vacuum line removes the fluid and any materials contained in the fluid,
wherein an operator views the apparatus and area via the at least one camera.

23. The system of claim 22, further comprising control lines configured to control movement of the at least two rotatable joints, wherein the control lines are connected to a control station and are configured to allow the operator to remotely operate the apparatus and track system.

24. A method of cleaning an area, comprising:
magnetically mounting a cleaning apparatus within the area, the cleaning apparatus comprising:
a base having at least one magnet;
an arm having a first end attached to the base and extending away from the base; and
a nozzle attached to a second end of the arm,
wherein the arm comprises at least two rotatable joints allowing for manipulation of the nozzle;
connecting the cleaning apparatus to a high pressure fluid line;
remotely operating the cleaning apparatus to control a direction of flow from the high pressure fluid line;
directing a flow of fluids towards material on a surface of the area to remove the material from the surface; and
removing the fluids and material via a vacuum line.

25. The method of claim 24, wherein the apparatus is remotely operated via control lines connected from a control station to the apparatus, the control lines configured to control movement of the at least two rotatable joints.

26. The method of claim 25, further comprising magnetically attaching the at least one magnet to a track system, wherein the track system includes first and second longitudinal bars movably attached to each other, wherein the apparatus is movably attached to the first bar, wherein the second bar is movably attached to a mounting structure, wherein the first and second bars and the apparatus are movable in multiple directions and axes.

27. The method of claim 26, wherein the apparatus is programmed by the steps of:
instructing a route to the apparatus by the steps of:
controlling the apparatus and defining the route via implementation of a starting cleaning sequence, wherein the route includes an initial cleaning of the area including a sequence of maneuvers positioning the apparatus for optimal cleaning purposes; and
logging resulting route data from sensor and positioning components to a memory, wherein the sensor and positioning components are located on at least one of the apparatus and track system;
processing logged route data into a route profile, wherein the route profile includes a defined optimal cleaning sequence; and
reproducing the route profile automatically using a Programmable Logic Control (PLC) device.

28. The method of claim 27, wherein the apparatus is operated by the steps of:
implementing the starting cleaning sequence using the PLC device, wherein the PLC device is configured to receive an electrical signal from the sensor and positioning components once the starting cleaning sequence is implemented;
sending the signal to an Electro-Hydraulic Flow Control (EHFC) device via the PLC device, wherein the EHFC device is configured to provide at least one of hydraulic, pneumatic, and electrical flow;
positioning the apparatus and arm in an optimal cleaning position based on the signal and flow via the EHFC device; and
performing a cleaning motion for a pre-determined amount of time according to the defined optimal cleaning sequence,
wherein the PLC device is configured to repeat the defined optimal cleaning sequence by simultaneously sending and receiving signals.

29. The method of claim 28, further comprising observing movements of the cleaning apparatus and track system via at least one camera mounted within the area or on the apparatus.

30. The method of claim 29, wherein the steps for operating the apparatus are repeated until the area is cleaned.

31. The method of claim 30, further comprising turning off the at least one magnet to dismount the cleaning apparatus.

32. The method of claim 24, wherein the at least one magnet is electro-magnetic.

33. A cleaning apparatus, comprising:
a base;
an arm having a first end attached to the base and extending away from the base; and
a nozzle attached to a second end of the arm,
wherein the arm includes at least two rotatable joints allowing for manipulation of the nozzle.

34. The apparatus of claim 33, wherein base extensions extend from the base at a first end and attach to a plate at a second end.

35. The apparatus of claim 34, wherein the arm includes:
a first arm member attached to the plate; and
a second arm member attached to the first arm member,
wherein the first arm member is configured to rotate relative to the plate around a first axis,
wherein the second arm member is configured to rotate relative to the first arm member around a second axis that is substantially perpendicular to the first axis.

36. The apparatus of claim 35, further comprising a pressure line mount configured to facilitate flow of high pressure fluids for cleaning, wherein the pressure line mount is connected to the second arm member via attachment to the nozzle at a first end and a pressure line at a second end.

37. The apparatus of claim 36, further comprising control lines connected to a control station, the control lines configured to control movement of the at least two rotatable joints.
